(19) United States
(12) Patent Application Publication
(10) Pub. No.: US 2020/0311641 A1
(43) Pub. Date: Oct. 1, 2020

(54) PARKING AREA MANAGEMENT DEVICE, PARKING AREA MANAGEMENT METHOD, AND RECORDING MEDIUM

(71) Applicant: HONDA MOTOR CO., LTD., Tokyo (JP)

(72) Inventors: Junpei Noguchi, Wako-shi (JP); Chie Sugihara, Tokyo (JP); Yuta Takada, Tokyo (JP); Ryoma Taguchi, Tokyo (JP)

(21) Appl. No.: 16/823,374

(22) Filed: Mar. 19, 2020

(30) Foreign Application Priority Data
Mar. 29, 2019 (JP) 2019-067301

(51) Int. Cl. G06Q 10/06; G06Q 10/02; G06F 16/2457; G06K 9/00

(52) U.S. Cl. CPC G06Q 10/06315; G06Q 10/02; G05D 1/0088; G06F 16/24578; G06K 9/00812; G06Q 10/06312

(57) ABSTRACT

A parking area management device includes: a recognizer that recognizes vehicles in a parking area; and a parking position determiner that determines a parking position of vehicles in the parking area on the basis of a vehicle length and a vehicle width of each of the vehicles recognized by the recognizer. The parking position determiner virtually sets parking frames in which the vehicles can park on the basis of outer dimensions of the vehicles recognized by the recognizer and map information of the parking area and determines the set parking frames as parking positions of the vehicles in the parking area.

### CROSS-REFERENCE TO RELATED APPLICATION

This application claims priority to and the benefit from Japanese Patent Application No. 2019-067301, filed on Mar. 29, 2019, the contents of which are hereby incorporated by reference into the present application.

### BACKGROUND

### Field of the Invention

The present invention relates to a parking area management device, a parking area management method, and a recording medium.

### Description of Related Art

In recent years, research on automatically controlling vehicles has progressed. In this context, a technique for calculating the time taken until it is possible to park when trying to park in a parking area in a full state has been disclosed (for example, see International Patent Publication WO2006/109828).

### SUMMARY

However, the conventional technique does not take how to allow a vehicle to efficiently park in a parking space in a parking area into sufficient consideration. In the conventional technique, when a parking area accepts an advance reservation, there is a possibility that the parking area may be in a state in which parking is not possible despite there being a reservation, and at which position a vehicle without an advance reservation should park such that it does not block movement in the parking area while enabling a vehicle with an advance reservation to park has not taken into sufficient consideration.

Embodiments of the present invention are made in view of such circumstances, and one of the objects thereof is to provide a parking area management device, a parking area management method, and a recording medium capable of allowing vehicles to efficiently park in a parking space in a parking area to enable a reserved vehicle to park.

A parking area management device, a parking area management method, and a recording medium according to the present invention employ the following configurations.

(1) A parking area management device according to an aspect of the present invention is a parking area management device including: a recognizer that recognizes vehicles in a parking area; and a parking position determiner that virtually sets parking frames in which the vehicles can park on the basis of outer dimensions of the vehicles recognized by the recognizer and map information of the parking area and determines the set parking frames as parking positions of the vehicles in the parking area.

(2) In the aspect of (1), the parking position determiner determines the parking frames as the parking positions of the vehicles in the parking area and rearranges the vehicles in the parking frames.

(3) In the aspect of (2), the parking area management device further includes: a reservation section that accepts an advance reservation for parking the vehicle in the parking area; and a rank setter that sets a rank of contributing to the rearrangement to a vehicle of which the advance reservation has been accepted by the reservation section, and when it is determined that a full state is not resolved even if the vehicle without an advance reservation is moved, the parking position determiner determines that the vehicle to which a high rank is set by the rank setter is to contribute to the rearrangement.

(4) In the aspect of (3), the parking position determiner performs the rearrangement so that a moving distance of the vehicle with an advance reservation is minimized.

(5) In the aspect of (3), the rank setter sets a lower rank to the vehicle of which the moving distance increases when contributing to the rearrangement among the vehicles with an advance reservation.

(6) In the aspect of (3), the rank setter sets a higher rank to a vehicle capable of performing autonomous travel of a higher difficulty level.

(7) In the aspect of (3), the rank setter sets a lower rank to a vehicle which has contributed to rearrangement in the past and of which the moving distance in contributing to rearrangement is long among the vehicles with an advance reservation.

(8) In the aspect of (3), the rank setter sets a lower rank to a vehicle having a relatively large vehicle width.

(9) In the aspect of (3), the rank setter sets a lower rank to a vehicle present in a space having a high space filling rate in a vehicle width direction with respect to a parkable region.

(10) In the aspect of (3), the parking position determiner moves the vehicle without an advance reservation to a position different from the parking position when it is not possible to determine a parking position of a new vehicle even when rearrangement is performed.

(11) In the aspect of (3), the recognizer acquires a recognition result of other vehicles in the parking area and recognizes outer dimensions of the other vehicles and a space filling rate in a vehicle width direction with respect to a parkable region.

(12) In the aspect of (3), the parking position determiner determines whether the parking area will reach a full state in the future on the basis a reservation received by the reservation section and a parking position of the vehicle parked in advance in the parking area and determines that rearrangement is to be performed when it is determined that the full state will be reached.

(13) A parking area management method according to an aspect of the present invention is a parking area management method for causing a computer to execute: recognizing vehicles in a parking area; and virtually setting parking frames in which the vehicles can park on the basis of outer dimensions of the recognized vehicles and map information of the parking area and determining the set parking frames as parking positions of vehicles in the parking area.

(14) A recording medium according to an aspect of the present invention is a non-transitory computer-readable recording medium having a program stored therein, the program causing a computer to execute: recognizing vehicles in a parking area; and virtually setting parking frames in which the vehicles can park on the basis of outer dimensions of the recognized vehicles and map information of the parking area and determining the set parking frames as parking positions of vehicles in the parking area.

According to aspects (1) to (13), it is possible to allow vehicles to efficiently park in a parking space in a parking area.

According to aspects (3) to (11), it is possible to allow a reserved vehicle to park preferentially and enable a vehicle without an advance reservation to park at a position where it does not block movement of other vehicles in a parking area.

### BRIEF DESCRIPTION OF THE DRAWINGS

FIG. 1 is a block diagram of a vehicle system which uses an automated driving controller.

FIG. 2 is a diagram illustrating a functional configuration of a first controller and a second controller.

FIG. 3 is a diagram schematically illustrating a scene in which an autonomous parking event is executed.

FIG. 4 is a diagram illustrating an example of a configuration of a parking area management device.

FIG. 5 is a diagram for describing the status of a vehicle.

FIG. 6 is a diagram for describing an example of a parking position before rearrangement.

FIG. 7 is a diagram illustrating an example of a parking position after rearrangement.

FIG. 8 is a flowchart illustrating an example of the flow of a process of the parking area management device.

FIG. 9 is a flowchart illustrating an example of the flow of an order setting process of a rank setter.

FIG. 10 is a diagram illustrating an example of a hardware configuration of a parking area management device according to an embodiment.

### DESCRIPTION OF EMBODIMENTS

Hereinafter, embodiments of a parking area management device, a parking area management method, and a recording medium of the present invention will be described with reference to the drawings.

### [Overall Configuration]

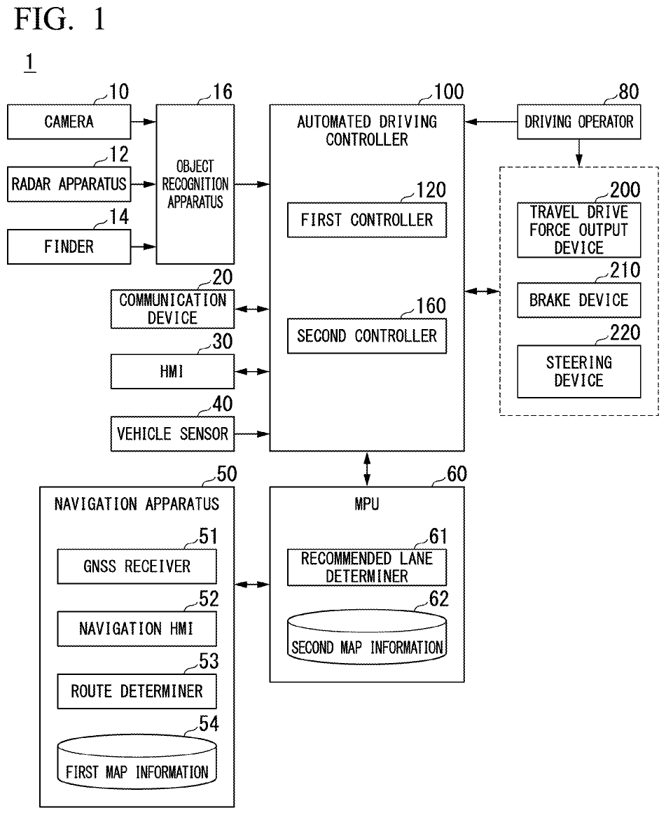

FIG. 1 is a block diagram of a vehicle system 1 which uses an automated driving controller 100. A vehicle in which the vehicle system 1 is mounted is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. An electric motor operates using electric power generated by a generator connected to an internal combustion engine or an electric power discharged by secondary batteries or fuel-cell batteries.

The vehicle system 1 includes, for example, a camera 10, a radar apparatus 12, a finder 14, an object recognition apparatus 16, a communication device 20, a human machine interface (HMI) 30, a vehicle sensor 40, a navigation apparatus 50, a map positioning unit (MPU) 60, a driving operator 80, an automated driving controller 100, a travel drive force output device 200, a brake device 210, and a steering device 220.

These apparatuses and devices are connected to each other by a multiplex communication line such as a controller area network (CAN) communication line, a serial communication line, a wireless communication network, and the like. Moreover, the components illustrated in FIG. 1 are examples only, some components may be omitted and other components may be added.

The camera 10 is, for example, a digital camera which uses a solid-state imaging device such as a charge coupled device (CCD) or a complementary metal oxide semiconductor (CMOS). The camera 10 is attached to an arbitrary position of a vehicle (hereinafter referred to as a vehicle M) in which the vehicle system 1 is mounted. When capturing images on the front side, the camera 10 is attached to an upper part of a front windshield or a back surface of a rear-view mirror. The camera 10, for example, captures the images around the vehicle M repeatedly and periodically. The camera 10 may be a stereo camera.

The radar apparatus 12 emits radio waves such as millimeter waves to the surroundings of the vehicle M and detects radio waves (reflected waves) reflected from an object to detect at least the position (the distance and direction) of the object. One or a plurality of radar apparatuses 12 are attached to arbitrary positions of the vehicle M. The radar apparatus 12 may detect the position and the speed of an object according to a frequency modulated continuous wave (FM-CW) method.

The finder 14 is a light detection and ranging (LIDAR). The finder 14 radiates light to the periphery of the vehicle M and measures scattering light. The finder 14 detects the distance to an object on the basis of the time taken to receive light after the light was emitted. The radiated light is pulsating laser light, for example. The finder 14 is attached to an arbitrary position on the vehicle M.

The object recognition apparatus 16 performs sensor fusion processing on detection results obtained by some or all of the camera 10, the radar apparatus 12, and the finder 14 to recognize the position, the kind, the speed, and the like of an object. The object recognition apparatus 16 outputs the recognition results to the automated driving controller 100. The object recognition apparatus 16 may output the detection results obtained by the camera 10, the radar apparatus 12, and the finder 14 to the automated driving controller 100 as they are. The object recognition apparatus 16 may be omitted from the vehicle system 1.

The communication device 20, for example, communicates with other vehicles present around the vehicle M, a parking area management device (to be described later), or various server devices using a cellular network, a Wi-Fi network, Bluetooth (registered trademark), a dedicated short range communication (DSRC), or the like.

The HMI 30 presents various pieces of information to a user of the vehicle M and receives input operations of the user. The HMI 30 includes various display devices, speakers, buzzers, touch panels, switches, keys, and the like.

The vehicle sensor 40 includes a vehicle speed sensor that detects the speed of the vehicle M, an acceleration sensor that detects an acceleration, a yaw-rate sensor that detects an angular speed about a vertical axis, an azimuth sensor that detects the direction of the vehicle M, and the like.

The navigation apparatus 50 includes, for example, a global navigation satellite system (GNSS) receiver 51, a navigation HMI 52, and a route determiner 53. The navigation apparatus 50 stores first map information 54 in a storage device such as a hard disk drive (HDD) or a flash memory. The GNSS receiver 51 specifies the position of the vehicle M on the basis of signals received from GNSS satellites. The position of the vehicle M may be specified or complemented by an inertial navigation system (INS) which uses the output of the vehicle sensor 40. The navigation HMI 52 includes a display device, a speaker, a touch panel, keys, and the like. The navigation HMI 52 may be partially or entirely shared with the HMI 30. For example, the route determiner 53 determines a route (hereinafter a map route) from the position (or an input arbitrary position) of the vehicle M specified by the GNSS receiver 51 to a destination input by a user using the navigation HMI 52 by referring to the first map information 54. The first map information 54 is information in which a road shape is represented by links indicating roads and nodes connected by links. The first map information 54 may include the curvature of a road, point of interest (POI) information, and the like. The map route is output to the MPU 60. The navigation apparatus 50 may perform route guidance using the navigation HMI 52 on the basis of the map route. The navigation apparatus 50 may be realized by the functions of a terminal device such as a smartphone or a tablet terminal held by a user. The navigation apparatus 50 may transmit a present position and a destination to a navigation server via the communication device 20 and acquire a route equivalent to a map route from the navigation server.

The MPU 60 includes a recommended lane determiner 61, for example, and stores second map information 62 in a storage device such as a HDD or a flash memory. The recommended lane determiner 61 divides the map route provided from the navigation apparatus 50 into a plurality of blocks (for example, the route may be partitioned every 100 [m] in relation to a vehicle traveling direction) and determines a recommended lane for each block by referring to the second map information 62. The recommended lane determiner 61 determines that the vehicle is traveling in a certain lane from the left. When a branching point is present on a map route, the recommended lane determiner 61 determines a recommended lane so that the vehicle M can travel along a reasonable route for proceeding to a branch destination.

The second map information 62 is map information with higher accuracy than the first map information 54. The second map information 62 includes, for example, information on the center of a lane or information on the boundaries of a lane. The second map information 62 may include road information, traffic regulation information, address information (address and postal codes), facility information, telephone number information, and the like. The second map information 62 may be updated as necessary by the communication device 20 communicating with other devices.

The driving operator 80 includes, for example, an acceleration pedal, a brake pedal, a shift lever, a steering wheel, a deformed steering wheel, a joystick, and other operators. Sensors that detect an amount of operation or the presence of an operation are attached to the driving operator 80, and the detection results are output to any one or both of the automated driving controller 100 or the travel drive force output device 200, the brake device 210, and the steering device 220.

The automated driving controller 100 includes, for example, a first controller 120 and a second controller 160. The first controller 120 and the second controller 160 each are realized when a hardware processor such as a central processing unit (CPU) or the like executes a program (software). Some or all of these components may be realized by hardware (a circuit portion; including circuitry) such as large scale integration (LSI), an application specific integrated circuit (ASIC), a field-programmable gate array (FPGA), or a graphics processing unit (GPU) and may be realized by the cooperation of software and hardware. The program may be stored in advance in a storage device (a non-transitory storage medium) such as a HDD or a flash memory of the automated driving controller 100 and may be stored in a removable storage medium such as a DVD or a CD-ROM and be installed in a HDD or a flash memory of the automated driving controller 100 when a storage medium (a storage device including a non-transitory storage medium) is attached to a drive device.

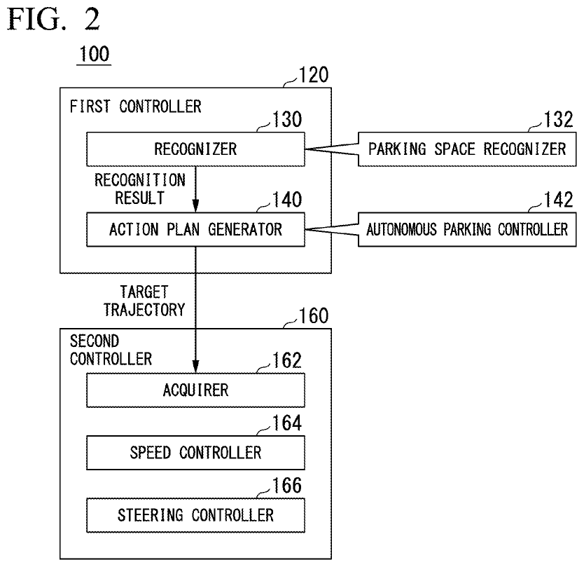

FIG. 2 is a diagram illustrating a functional configuration of the first controller 120 and the second controller 160. For example, the first controller 120 includes a recognizer 130 and an action plan generator 140. For example, the first controller 120 realizes the functions of artificial intelligence (AI) and the functions of a predetermined model in parallel. For example, a function of “recognizing an intersection” may be realized by executing recognition of an intersection by deep learning and recognition based on a predetermined condition (signals, road marks, and the like which can be subjected to pattern matching) in parallel and scoring both recognition results to make comprehensive evaluation. In this way, the reliability of automated driving is secured.

The recognizer 130 recognizes the state such as a position of an object around the vehicle M, a speed, an acceleration, and the like on the basis of the information input from the camera 10, the radar apparatus 12, and the finder 14 via the object recognition apparatus 16. The object position is recognized as the position on an absolute coordinate system in which a representative point (the center of gravity, the center of a driving shaft, or the like) of the vehicle M is at the origin, for example, and is used for control. The object position may be represented by a representative point such as the center of gravity or a corner of the object and may be represented by a region. The “state” of an object may include the acceleration or a jerk of an object or an “action state” (for example, whether the object has changed or is trying to change lanes).

For example, the recognizer 130 recognizes a lane (a traveling lane) in which the vehicle M is traveling. For example, the recognizer 130 recognizes the traveling lane by comparing a pattern (for example, an arrangement of solid lines and broken lines) of lane marks obtained from the second map information 62 and a pattern of lane marks around the vehicle M recognized from the images captured by the camera 10. The recognizer 130 may recognize the traveling lane by recognizing runway boundaries (road boundaries) including lane marks, road shoulders, curbs, a median strip, guard rails, and the like without being limited to the lane marks. In this recognition, the position of the vehicle M acquired from the navigation apparatus 50 and the processing results of the INS may be also taken into consideration. The recognizer 130 recognizes a temporary stop line, an obstacle, a red sign, a toll booth, and other road events.

When recognizing the traveling lane, the recognizer 130 recognizes the position and a direction of the vehicle M in relation to the traveling lane. For example, the recognizer 130 may recognize an offset from a lane center of a reference point of the vehicle M and an angle between the traveling direction of the vehicle M and an extension line of the lane center as the relative position and the direction of the vehicle M in relation to the traveling lane. Instead of this, the recognizer 130 may recognize the position or the like of the reference point of the vehicle M in relation to any one of side ends (lane marks or road boundaries) of the traveling lane as the relative position of the vehicle M in relation to the traveling lane. The recognizer 130 recognizes outer dimensions (for example, a vehicle length, a vehicle width, and the like) of other vehicle being parked, a space filling rate in a vehicle width direction with respect to a parkable region, and the like. The filling rate will be described later.

The recognizer 130 includes a parking space recognizer 132 that is activated in an autonomous parking event to be described later. The details of the function of the parking space recognizer 132 will be described later.

In principle, the action plan generator 140 generates a target trajectory along which the vehicle M travels in the future automatically (regardless of an operation of a driver) so that the vehicle M travels in a recommended lane determined by the recommended lane determiner 61 and it is possible to cope with a surrounding situation of the vehicle M. The target trajectory includes a speed element, for example. For example, the target trajectory is represented as a sequential arrangement of positions (trajectory points) that the vehicle M has to reach. The trajectory points are positions that the vehicle M has to reach every predetermined travel distance (for example, approximately every several [m]) as the distance along a road. In addition to this, a target speed and a target acceleration every predetermined sampling period (for example, approximately every 0.x [sec]) are generated as part of the target trajectory. The trajectory points may be the positions that the vehicle M has to reach at respective sampling time points of the predetermined sampling periods. In this case, the information of the target speed and the target acceleration is represented by the intervals of the trajectory points.

The action plan generator 140 may set an automated driving event when generating the target trajectory. The automated driving event includes a constant speed travel event, a low-speed following travel event, a lane changing event, a diverging event, a merging event, a takeover event, and an autonomous parking event in which an unmanned vehicle travels and parks during valet parking. The action plan generator 140 generates a target trajectory corresponding to an activated event. The action plan generator 140 includes an autonomous parking controller 142 activated when an autonomous parking event is executed. The details of the function of the autonomous parking controller 142 will be described later.

The second controller 160 controls the travel drive force output device 200, the brake device 210, and the steering device 220 so that the vehicle M passes along the target trajectory generated by the action plan generator 140 at a scheduled time.

The second controller 160 includes, for example, an acquirer 162, a speed controller 164, and a steering controller 166. The acquirer 162 acquires information on the target trajectory (trajectory points) generated by the action plan generator 140 and stores the information in a memory (not illustrated). The speed controller 164 controls the travel drive force output device 200 or the brake device 210 on the basis of a speed element included in the target trajectory stored in the memory. The steering controller 166 controls the steering device 220 according to the degree of curving of the target trajectory stored in the memory. The processes of the speed controller 164 and the steering controller 166 are realized by a combination of feedforward control and feedback control, for example. As an example, the steering controller 166 executes feedforward control according to the curvature of a road in front of the vehicle M and feedback control based on an offset from a target trajectory in combination.

The travel drive force output device 200 outputs a travel drive force (torque) for a vehicle to travel to driving wheels. The travel drive force output device 200 includes a combination of an internal combustion engine, an electric motor, and a transmission and an electronic controller (ECU) that controls these components. The ECU controls the above-mentioned components according to the information input from the second controller 160 or the information input from the driving operator 80.

The brake device 210 includes, for example, a brake caliper, a cylinder that delivers hydraulic pressure to the brake caliper, an electric motor that generates hydraulic pressure in the cylinder, and a brake ECU. The brake ECU controls the electric motor according to the information input from the second controller 160 or the information input from the driving operator 80 so that brake torque corresponding to a braking operation is output to each wheel. The brake device 210 may include a backup mechanism that delivers hydraulic pressure generated by an operation of a brake pedal included in the driving operator 80 to a cylinder via a master cylinder. The brake device 210 is not limited to the above-described configuration and may be an electrically-controlled hydraulic-pressure brake device that controls an actuator according to information input from the second controller 160 and delivers hydraulic pressure of the master cylinder to a cylinder.

The steering device 220 includes, for example, a steering ECU and an electric motor. The electric motor, for example, applies a force to a rack-and-pinion mechanism to change the direction of a steering wheel. The steering ECU drives an electric motor according to the information input from the second controller 160 or the information input from the driving operator 80 to change the direction of the steering wheel.

### [Autonomous Parking Event: During Entering]

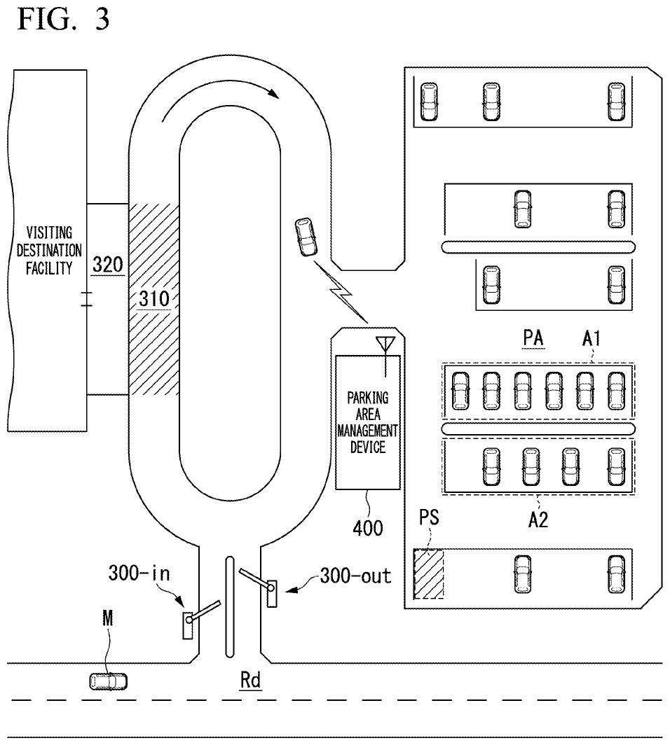

The autonomous parking controller 142 causes the vehicle M to park in a parking space on the basis of the information acquired from the parking area management device 400 with the aid of the communication device 20, for example. FIG. 3 is a diagram schematically illustrating a scene in which an autonomous parking event is executed.

Gates 300-in and 300-out are provided in a route from a road Rd to a visiting destination facility in FIG. 3. The vehicle M passes through the gate 300-in and proceeds to a stopping area 310 by manual driving or automated driving. The stopping area 310 is near a platform area 320 connected to the visiting destination facility. Eaves for blocking snow and rain are provided in the platform area 320. Cameras (not illustrated) for imaging passages and a parking space are provided in the parking area PA.

In the following description, it is assumed that an advance reservation is accepted in a partial region or an entire region of the parking area PA. A user of the vehicle M makes a usage reservation for the parking area PA with respect to the parking area management device 400 at a scheduled timing in a visiting destination facility, at the start of boarding the vehicle M, an arrival timing in the visiting destination facility, or the like. The parking area management device 400 may accept vehicles and users without an advance reservation. However, in this case, the priority right to use facilities in the parking area PA may be given to reserved vehicles and users or a discount for advance reservation may be applied to a parking fee.

When the vehicle M enters a valet parking area, a user stops the vehicle M at an exclusive position (hereinafter, a stopping area 310) in front of a parking space and alight from the vehicle M using a platform area 320 adjacent to the stopping area 310. When the vehicle M has entered the valet parking area, a user boards the vehicle M using the platform area 320 similarly during boarding.

A buffer stop for stopping vehicles, a partition line for distinguishing a packable position and a passage, and a mark serving as a reference of a stopping position may be formed in the parking area PA. After a user alights in the stopping area 310, the vehicle M performs automated driving in an unmanned manner and starts an autonomous parking event of moving up to a parking space PS in the parking area PA. A trigger for starting the autonomous parking event may be an arbitrary operation of a user and may be a predetermined signal received wirelessly from the parking area management device 400, for example. When starting the autonomous parking event, the autonomous parking controller 142 controls the communication device 20 such that a parking request is sent to the parking area management device 400. The vehicle M moves from the stopping area 310 to the parking area PA according to the guidance of the parking area management device 400 or while performing sensing itself.

In FIG. 3, regions A1 and A2 are regions having the same area, and a larger number of vehicles are stopping in the region A1 than the region A2. In the illustrated case, the region A1 can be said to be in a state in which the filling rate in the vehicle width direction of vehicles is high.

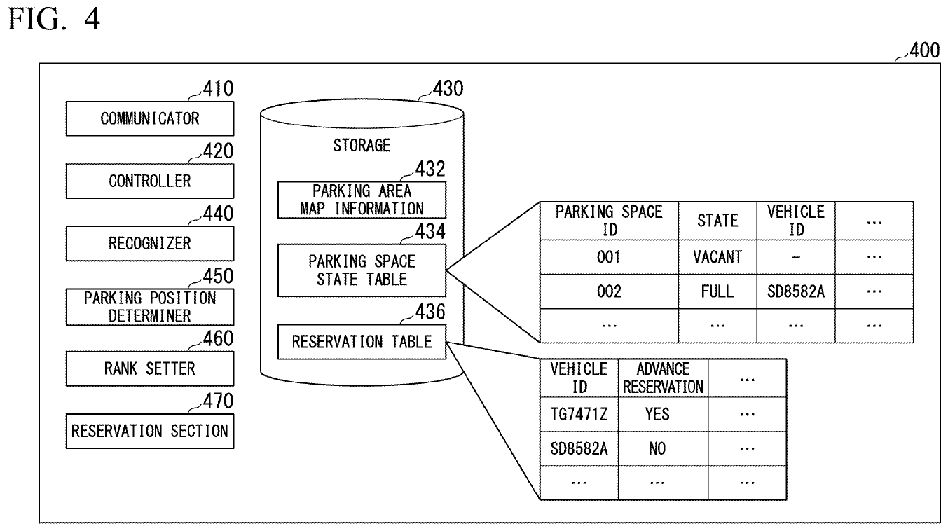

FIG. 4 is a diagram illustrating an example of a configuration of the parking area management device 400. The parking area management device 400 includes, for example, a communicator 410, a controller 420, a storage 430, a recognizer 440, a parking position determiner 450, a rank setter 460, and a reservation section 470. Information such as parking area map information 432, a parking space state table 434, and a reservation table 436 is stored in the storage 430.

The communicator 410 wirelessly communicates with vehicles other than the vehicle M. The controller 420 guides the vehicle to the parking space PS on the basis of the information acquired by the communicator 410 and the information stored in the storage 430. The parking area map information 432 is information showing the structure of the parking area PA geometrically. The parking area map information 432 includes the coordinates of respective parking spaces PS. The parking space state table 434 correlates a parking space ID which is identification information of the parking space PS with a state indicating whether the space is in a vacant state or a full (parked in) state and a vehicle ID which is identification information of a parked vehicle in a full state. The reservation table 436 correlates a reservation time and a vehicle ID with the parking space ID.

When the communicator 410 receives a parking request from the vehicle, the controller 420 extracts the parking space PS in a vacant state by referring to the parking space state table 434, acquires the position of the extracted parking space PS from the parking area map information 432, and transmits an ideal route to the acquired position of the parking space PS to the vehicle using the communicator 410. The controller 420 instructs a specific vehicle to stop or move slowly as necessary on the basis of a positional relationship between a plurality of vehicle so that a plurality of vehicles do not proceed to the same position simultaneously.

In a vehicle (hereinafter referred to as the vehicle M) having received the route, the autonomous parking controller 142 generates a target trajectory based on the route. When the vehicle comes near the target parking space PS, the parking space recognizer 132 recognizes parking frame lines or the like that define the parking space PS, recognizes a detailed position of the parking space PS, and provides the detailed position to the autonomous parking controller 142. Upon receiving the detailed position, the autonomous parking controller 142 corrects the target trajectory and causes the vehicle M to be parked in the parking space PS.

The recognizer 440 recognizes vehicles being parked and travelling in the parking area PA. The recognizer 440 may recognize vehicles in the parking area PA using images captured by cameras provided in respective places of the parking area PA and may acquire the recognition results of the recognizers 130 of respective vehicles to recognize vehicles, and may acquire information corresponding to a vehicle type via a network. For example, the recognizer 440 acquires the recognition results of the recognizers 130 of respective vehicles and recognizes outer dimensions of each vehicle, a space filling rate in a vehicle width direction with respect to the parkable region, and the like. The recognizer 440 may recognize the sizes of specific vehicle widths and lengths of respective vehicles and may recognize (or estimate) the vehicle types of respective vehicles to recognize (or estimate) the vehicle widths and lengths. When the recognizer 440 may recognize the vehicle type of each vehicle to recognize the outer dimensions, the recognizer 440 may apply the vehicle types of respective vehicles to classifications such as “super large, large, medium, and small”.

The parking position determiner 450 determines the parking positions of vehicles that use the parking area PA. For example, the parking position determiner 450 virtually sets parking frames in which respective vehicles can park on the basis of the outer dimensions of the respective vehicles recognized by the recognizer 440 and the parking area map information 432 and determines the set parking frame as a parking position of the vehicle M in the parking area PA. The parking position determiner 450 may determine a parking position of a vehicle that is going to park from now on in the parking area PA and may determine that the parking position of a vehicle parked in advance is to be changed to another parking position. The parking position determiner 450 determines the parking positions of the respective vehicles so that the parkable region of the parking area PA can be used efficiently. In the following description, determining the parking positions of vehicles including parked vehicles so that the parkable region of the parking area PA can be used efficiently is sometimes referred to as “rearrangement”.

The parking position determiner 450 determines whether the parking area PA will reach a full state in a near future on the basis of reservations received by the reservation section 470 and the parking positions of vehicles parked in advance in the parking area PA and determines that rearrangement is to be performed when it is determined that a full state will be reached. In this case, the parking position determiner 450 may determine that rearrangement is to be performed only in a partial region of the parking area PA and may determine that rearrangement is to be performed in a plurality of regions, and may determine that rearrangement is to be performed in the entire parking area PA.

The parking position determiner 450 may store the moving distances of respective vehicles when rearrangement was performed in the past in the storage 430. The information on the distance may be a theoretical moving distance calculated by the parking position determiner 450 and may be the actual moving distance of a vehicle having contributed to the rearrangement, which is reported and acquired from the vehicle. The parking position determiner 450 may store the moving distances of the respective vehicles having contributed to rearrangement in the present parking in the storage 430 and may store the moving distances of the respective vehicles having contributed to rearrangement in a predetermined period (for example, past one month) in the storage 430.

The rank setter 460 sets the ranks of the respective vehicles contributing to rearrangement. A rank setting method will be described later.

The reservation section 470 accepts an advance reservation for using the parking area PA from the vehicle M a communication terminal used by the user of the vehicle M received via the communicator 410.

### [Autonomous Parking Event: During Exiting]

The autonomous parking controller 142 and the communication device 20 maintain an operation state even when the vehicle M is parked. When the communication device 20 receives a pickup request from a terminal device of a user, the autonomous parking controller 142 activates the system of the vehicle M to move the vehicle M up to the stopping area 310. In this case, the autonomous parking controller 142 controls the communication device 20 such that a start request is transmitted to the parking area management device 400. The controller 420 of the parking area management device 400 instructs a specific vehicle to stop or move slowly as necessary on the basis of a positional relationship between a plurality of vehicles so that a plurality of vehicles do not proceed to the same position simultaneously similarly to during entering. When the vehicle M is moved up to the stopping area 310 and has a user on board, the autonomous parking controller 142 stops operating, and after that, manual driving or automated driving based on another functional unit starts.

Without being limited to the above description, the autonomous parking controller 142 may find a vacant parking space itself on the basis of the detection results obtained by the camera 10, the radar apparatus 12, the finder 14, or the object recognition apparatus 16 regardless of communication and cause the vehicle M to park in the found parking space.

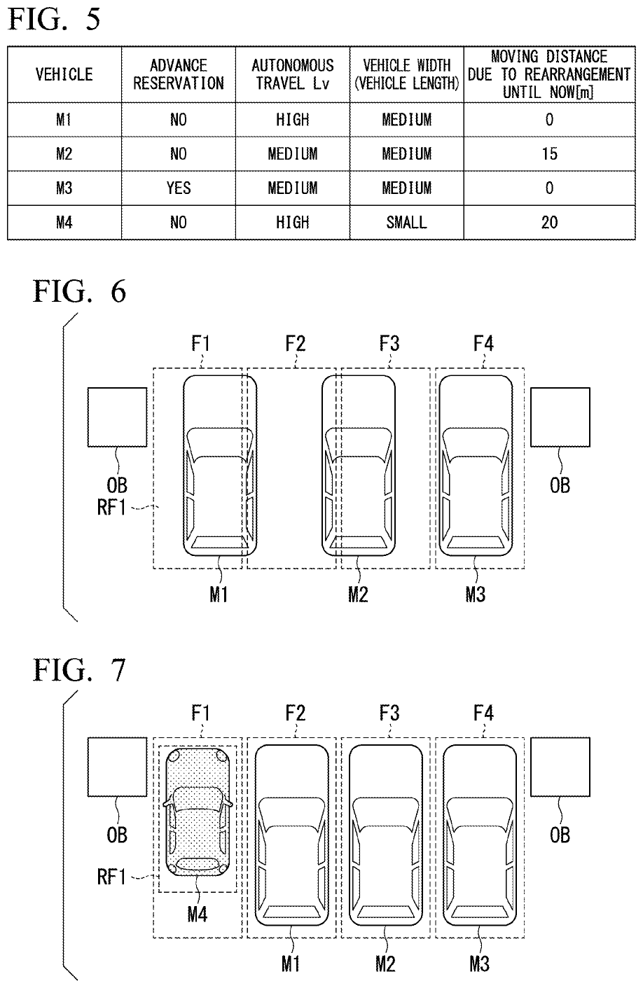

Hereinafter, a rearrangement process of the parking position determiner 450 will be described with reference to FIGS. 5 to 7. Hereinafter, it is assumed that the rearrangement target vehicles are 4 vehicles of vehicles M1 to M4.

FIG. 5 is a diagram for describing the status of vehicles M1 to M4. The reservation section 470 accepts an advance reservation for the parking area PA from the vehicle M3 only among the vehicles M1 to M4. The vehicles M1 and M4 are vehicles that can travel with an autonomous travel level of a higher difficulty level than the other vehicles. An autonomous travel level is evaluated to be high when a vehicle can recognize a position designated by the parking area management device 400 by itself in a parking area without partition lines and can park without guidance or assistance from other external devices or other vehicles.

The vehicle M4 is classified as a smaller vehicle type than the other vehicles. The vehicles M2 and M4 have contributed to rearrangement in the past.

FIG. 6 is a diagram for describing an example of a parking position before rearrangement. Three vehicles of M1 to M3 are stopping between obstacles OB before rearrangement is performed by the parking position determiner 450. It is assumed that the vehicle M4 is stopping in another region of the parking area PA.

The parking position determiner 450 virtually sets parking frames F1 to F4 assuming a case in which it is determined that rearrangement is to be performed in a partial region where the vehicles M1 to M3 are stopping so that vehicles are parked more efficiently. The parking position determiner 450 sets the size of the parking frames F1 to F4 on the basis of the outer dimensions of the vehicles M1 to M3 in order to simulate the rearrangement without greatly changing the parking positions of vehicles parked in advance. Such simulation may be performed at fixed periods and may be performed when it is expected that the parking area PA will reach a full state in a near future.

The parking position determiner 450 determines that the vehicle M3 may not be moved during rearrangement since the vehicle M3 is stopped inside the parking frame F4 set virtually. The parking position determiner 450 recognizes that there is an offset between the stopping positions of the vehicles M1 and M2 and each of the parking frames F1 to F3 set virtually. The parking position determiner 450 determines that the vehicles M1 and M2 are to contribute to rearrangement when it is estimated that another new vehicle can be parked if the stopping positions of the vehicles M1 and M2 are moved.

### [Determination of Rank]

In this case, the rank setter 460 sets a lower rank to the vehicle M3 so that the vehicle M3 does not easily become a contributing target since the vehicle M3 is an vehicle with an advance reservation. This is because the parking position determiner 450 determines an appropriate parking position for a vehicle with an vehicle with an advance reservation and a probability that such a vehicle stops at that position is higher than for vehicles without an advance reservation. The parking position determiner 450 simulates the rearrangement by referring to the rank setting result of the rank setter 460. When the simulation result shows that it is determined that the full state of a target parking region (or the entire parking area PA) is not resolved and it is determined that it is necessary for an vehicle with an advance reservation to contribute to rearrangement, the parking position determiner 450 simulates rearrangement so that the vehicle with an advance reservation becomes a contributing target.

However, the rank setter 460 sets a lower rank to a vehicle of which the moving distance increases when contributing to rearrangement among the vehicles with an advance reservation. Even when rearrangement is performed so that the vehicle with an advance reservation becomes a contributing target, the parking position determiner 450 performs rearrangement so that the moving distance of the vehicle with an advance reservation M3 is minimized.

The rank setter 460 may set a low rank to a vehicle having contributed to rearrangement in the past and having a long moving distance in the contributing rearrangement among the vehicles with an advance reservation. This is to give an advantage (incentive) for making an advance reservation for a parking area to the user of the vehicle M.

The rank setter 460 may set a higher rank to the vehicle M1 capable of performing autonomous travel of a higher difficulty level. Autonomous travel of a high difficulty level is the ability to perform travelling including parking position adjustment in several [cm] to several [mm] units, for example. The rank setter 460 may set a lower rank to a vehicle having a relatively large wheel width. In other words, the rank setter 460 may set a higher rank to a vehicle with a smaller turning circle so that an overall rearrangement can be performed more smoothly.

The rank setter 460 may set a lower rank to a vehicle present in a space having a high filling rate in the vehicle width direction with respect to a parkable region. The rank setter 460 may set a lower rank to vehicles stopping in the region A1 illustrated in FIG. 3, for example, than the vehicles stopping in the region A2 since the space filling rate in the vehicle width direction of the vehicles in the region A1 is higher than that of the vehicles in the region A2.

FIG. 7 is a diagram for describing an example of a parking position after rearrangement. The vehicles M1 and M2 are moved to the parking positions after rearrangement determined by the parking position determiner 450. The positions after rearrangement are the inner sides of the parking frames F2 and F3 set virtually, respectively. With rearrangement of the vehicles M1 and M2, a vacant space is formed in a region corresponding to the parking frame F1, and a new vehicle M4 can stop in that region.

If a parking frame (hereinafter a parking frame NF (not illustrated)) having a size smaller than the parking frame F1 and the same as a parking frame RF1 in which the vehicle M4 can stop or equal to or larger than the parking frame RF1 is secured in another parking region and the other vehicle MA (having the same outer dimensions as the vehicle M1 and the like) can park in the parking frame F1 but cannot park in the parking frame NF, the parking position determiner 450 determines that the vehicle M4 is to be moved to the parking frame NE

### [When Parking Region is Filled]

When a vehicle without an advance reservation that cannot stop in a parking region in the parking area PA occurs as a result of stopping an vehicle with an advance reservation preferentially in the parking region in the parking area PA, the parking position determiner 450 moves the vehicle without an advance reservation to a position different from the parking region at which it does not block the movement of the other vehicles. A position at which it does not block movement is a passage in the parking area PA or a vacant space near the stopping area 310, for example.

### [Rank Determination 1 Based on Residual Amount of Driving Energy]

The rank setter 460 may set the rank on the basis of whether the driving energy of the vehicle M can be supplemented in the parking area PA. When the driving energy of the vehicle M can be supplemented in the parking area PA (that is, a fueling facility, a charging spot, a non-contact charging system, or the like is present in the parking area PA), the rank may be determined on the basis of whether the vehicle M needs supplementing of a driving energy.

The rank setter 460 determines whether the driving energy of the vehicle M can be supplemented and sets a higher rank to such a vehicle M such that it actively contributes to rearrangement when the driving energy can be supplemented. When the driving energy of the vehicle M has decreased significantly due to contributing to rearrangement, the vehicle M may be given the right to supplement its driving energy in the present parking or the next parking as an incentive.

### [Rank Determination 2 Based on Residual Amount of Driving Energy]

The plant central management screen display unit 450 may determine the parking position by taking the position of the parking space PS and the residual energy amounts of respective vehicles into consideration as the elements of positioning. For example, when the parking space PS in FIG. 3 is a space where a driving energy can be supplemented, the rank setter 460 sets a rank on the basis of whether the driving energy of the vehicle M can be supplemented in the parking area PA.

The rank setter 460 sets the rank of the vehicle M to a lower rank, for example, when an instruction to supplement the driving energy during parking in the parking area PA is received from the user of the vehicle M or the driving energy of the vehicle M is an empty state. In this way, when the vehicle M requires supplementing of driving energy, the probability of contributing to rearrangement can be decreased.

A vehicle in the middle of supplementing of driving energy such as fueling or charging and a vehicle waiting near a supplement space for supplementing energy may be excluded from rearrangement targets. In this case, the parking position determiner 450 may exclude the corresponding vehicle from rearrangement candidates (or the rank setter 460 may exclude the corresponding vehicle from rank setting targets or set a lower rank thereto such that it does not contribute to rearrangement).

### [Process Flow: Rearrangement]

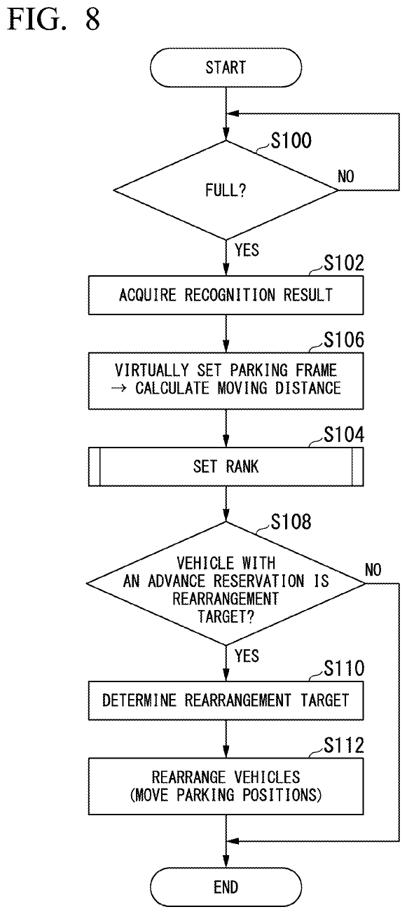

FIG. 8 is a flowchart illustrating an example of a process flow during rearrangement by the parking area management device 400.

First, the controller 420 determines whether the parking area PA will reach a full state in a near future on the basis of various pieces of information stored in the storage 430 and the recognition result of the recognizer 440 (step S100). When it is determined that the full state will not be reached in a near future, the process of step S100 is performed again after the elapse of a predetermined period. When it is determined that the full state will be reached in a near future, the recognizer 440 acquires the recognition result of the parking area PA (step S102).

Subsequently, the parking position determiner 450 virtually sets parking frames and calculates a moving distance when each vehicle is moved to the parking frame (step S106). Next, the rank setter 460 sets the rank of each vehicle (step S104).

Subsequently, the parking position determiner 450 determines whether an vehicle with an advance reservation will be a rearrangement target by referring to the processing result in step S104 (step S108). In the process of step S108, it may be selected whether a parking region in which rearrangement is performed will be a partial region only or the entire parking area PA.

When it is determined in the process of step S108 that the vehicle with an advance reservation is a rearrangement target, the parking position determiner 450 determines a rearrangement target vehicle including the vehicle with an advance reservation (step S110) and perform rearrangement of vehicles including movement of an actual parking position (step S112). When it is determined that the vehicle with an advance reservation is not a rearrangement target, the process of this flowchart ends. When it is determined that the vehicle with an advance reservation is not an rearrangement target, the parking position determiner 450 may determine a rearrangement target vehicle from vehicles without an advance reservation and perform rearrangement of vehicles including movement of an actual parking position with respect to the determined vehicles. In this way, the description of the process of this flowchart ends.

### [Process Flow: Rank Setting]

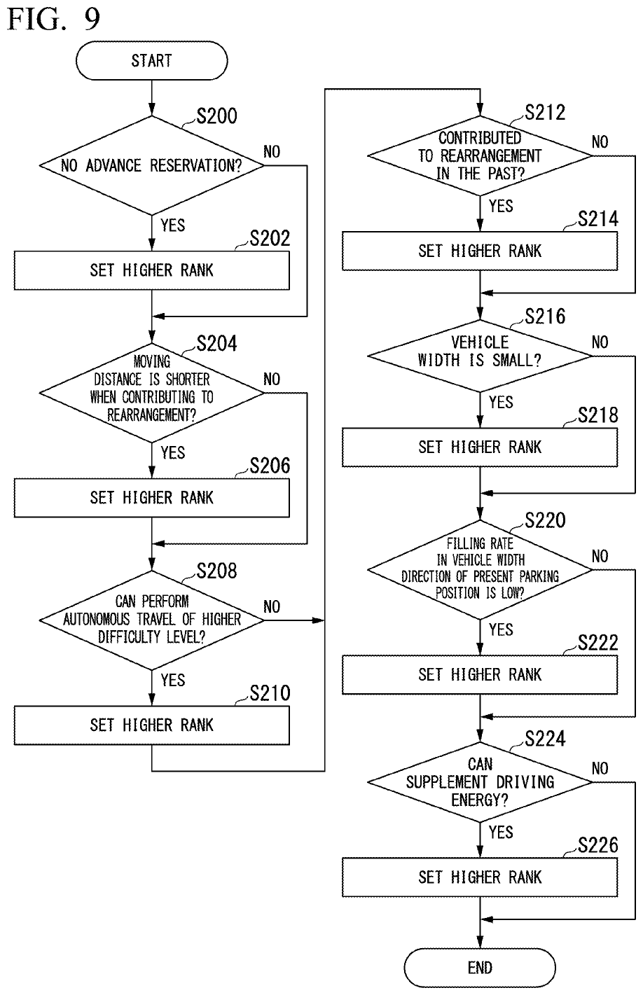

FIG. 9 is a flowchart illustrating an example of the flow of an order setting process of the rank setter 460. The flowchart illustrated in FIG. 9 corresponds to step S106 in FIG. 8.

First, the rank setter 460 determines whether a target vehicle has an advance reservation (step S200). When it is determined that the target vehicle does not have an advance reservation, the rank setter 460 sets a higher rank to the target vehicle (step S202). When it is determined that the target vehicle has an advance reservation, the rank setter 460 may proceed to the next process without performing a process (for example, the process of step S202) related to rank setting sectionicularly and may perform a process (a process of setting a lower rank) opposite to the process of step S202.

Subsequently, the rank setter 460 determines whether the moving distance when the target vehicle contributes to rearrangement is relatively shorter than that when other vehicles are moved (step S204). When it is determined that the moving distance of the target vehicle is shorter than that of other vehicles, the rank setter 460 sets a higher rank to the target vehicle (step S206). When it is determined that the moving distance is not shorter than that of other vehicles, the rank setter 460 may proceed to the next process without performing a process (for example, the process of step S206) related to rank setting sectionicularly and may perform a process opposite to the process of step S206.

Subsequently, the rank setter 460 determines whether the target vehicle can perform autonomous travel of a higher difficulty level than the other vehicle (step S208). When it is determined that the target vehicle can perform autonomous travel of a higher difficulty level, the rank setter 460 sets a higher rank to the target vehicle (step S210). When it is determined that the target vehicle cannot perform autonomous travel of a higher difficulty level, the rank setter 460 may proceed to the next process without performing a process (for example, the process of step S210) related to rank setting sectionicularly and may perform a process opposite to the process of step S210.

Subsequently, the rank setter 460 determines whether the target vehicle has contributed to rearrangement in the past (step S212). When it is determined that the target vehicle has not contributed to rearrangement in the past, the rank setter 460 sets a higher rank to the target vehicle (step S214). When it is determined that the target vehicle has contributed to rearrangement in the past, the rank setter 460 may proceed to the next process without performing a process (for example, the process of step S214) related to rank setting sectionicularly and may perform a process opposite to the process of step S214.

Subsequently, the rank setter 460 determines whether the target vehicle corresponds to a vehicle type having a relatively small vehicle width (step S216). When it is determined that the target vehicle corresponds to a vehicle type having a small vehicle width, the rank setter 460 sets a higher rank to the target vehicle (step S218). When it is determined that the target vehicle does not correspond to a vehicle type having a small vehicle width, the rank setter 460 may proceed to the next process without performing a process (for example, the process of step S218) related to rank setting sectionicularly and may perform a process opposite to the process of step S218. In the process of step S216, the rank setter 460 may use a vehicle length as a determination element in addition to the vehicle width of the target vehicle.

Subsequently, the rank setter 460 determines whether the space filling rate in the vehicle width direction of the present parking position of the target vehicle is low (step S220). When it is determined that the filling rate is low, the rank setter 460 sets a higher rank to the target vehicle (step S222). When it is determined that the filling rate is not low, the rank setter 460 may not perform the process (for example, the process of step S222) related to rank setting sectionicularly and may perform a process opposite to the process of step S222. Subsequently, the rank setter 460 determines whether the driving energy of the vehicle M can be supplemented in the parking area PA (step S224). When it is determined that the energy can be supplemented in the parking area PA, the rank setter 460 sets a higher rank to the vehicle M (step S226). When it is determined that the energy cannot be supplemented in the parking area PA, the rank setter 460 may not perform the process (for example, the process of step S226) related to rank setting sectionicularly and may perform a process opposite to the process of step S226. In this way, the description of this flowchart ends.

As described above, according to the parking area management device 400, the recognizer 440 recognizes respective vehicles in the parking area PA, the parking position determiner 450 virtually sets parking frames in which the vehicle M can park on the basis of the outer dimensions of the vehicles recognized by the recognizer 440 and the map information of the parking area and determines the set parking frame as a parking position of the vehicle in the parking area PA. In this way, it is possible to park the vehicle M efficiently in the parking area PA.

According to the parking area management device 400, when the controller 420 determines that a full state will be reached in a near future, the rank setter 460 sets a rank of allowing each vehicle to contribute to rearrangement on the basis of an element such as a reception state of an advance reservation by the reservation section 470, and the rank setter 460 determines that a vehicle to which a higher rank is set is to contribute to rearrangement. In this way, it is possible to enable the vehicle with an advance reservation M to park and allow the vehicle without an advance reservation M to park at a position at which it does not block movement in the parking area.

### [Hardware Configuration]

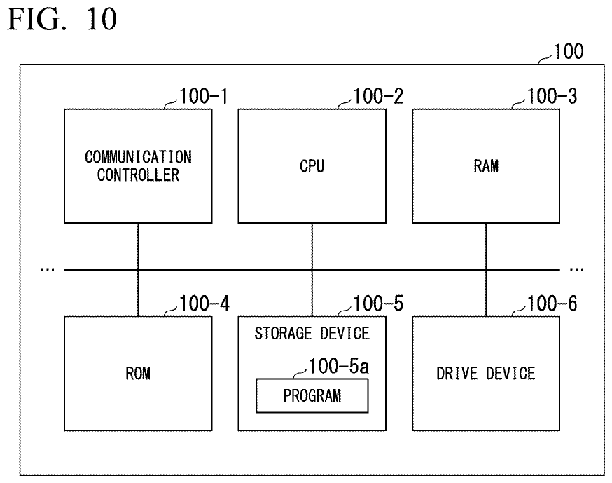

FIG. 10 is a diagram illustrating an example of a hardware configuration of the parking area management device 400 according to the embodiment. As illustrated in the drawing, the parking area management device 400 includes a communication controller 100-1, a CPU 100-2, a random access memory (RAM) 100-3 used as a working memory, a read only memory (ROM) 100-4 storing a boot program or the like, a storage device 100-5 such as a flash memory or a hard disk drive (HDD), and a drive device 100-6 which are connected to each other by an internal bus or a dedicated communication line. The communication controller 100-1 communicates with the components other than the automated driving controller 100. A program 100-5a executed by the CPU 100-2 is stored in the storage device 100-5. This program is deployed onto the RAM 100-3 by a direct memory access (DMA) controller (not illustrated) or the like and is executed by the CPU 100-2. In this way, some or all components of the parking area management device 400 are realized.

The above-described embodiment can be expressed as follows.

A parking area management device including:

a storage device that stores a program; and

a hardware processor, wherein

the hardware processor executes the program stored in the storage device to thereby:

recognize vehicles in a parking area; and

virtually set a parking frame in which the vehicles can park on the basis of the recognized outer dimensions of the vehicles and map information of the parking area and determine the set parking frames as parking positions of the vehicles in the parking area.

While modes for implementing the present invention have been described using embodiments, the present invention is not limited to these embodiments and various modifications and substitutions can be added without departing from the scope of the present invention.

What is claimed is:

1. A parking area management device comprising:
a recognizer that recognizes vehicles in a parking area; and
a parking position determiner that virtually sets parking frames in which the vehicles can park on the basis of outer dimensions of the vehicles recognized by the recognizer and map information of the parking area and determines the set parking frames as parking positions of the vehicles in the parking area.

2. The parking area management device according to claim 1, wherein
the parking position determiner determines the parking frames as the parking positions of the vehicles in the parking area and rearranges the vehicles in the parking frames.

3. The parking area management device according to claim 2, further comprising:
a reservation section that accepts an advance reservation for parking the vehicle in the parking area; and
a rank setter that sets a rank of contributing to the rearrangement to a vehicle of which the advance reservation has been accepted by the reservation section, wherein
when it is determined that a full state is not resolved even if the vehicle without an advance reservation is moved, the parking position determiner determines that the vehicle to which a high rank is set by the rank setter is to contribute to the rearrangement.

4. The parking area management device according to claim 3, wherein
the parking position determiner performs the rearrangement so that a moving distance of the vehicle with an advance reservation is minimized.

5. The parking area management device according to claim 3, wherein
the rank setter sets a lower rank to the vehicle of which the moving distance increases when contributing to the rearrangement among the vehicles with an advance reservation.

6. The parking area management device according to claim 3, wherein
the rank setter sets a higher rank to a vehicle capable of performing autonomous travel of a higher difficulty level.

7. The parking area management device according to claim 3, wherein
the rank setter sets a lower rank to a vehicle which has contributed to rearrangement in the past and of which the moving distance in contributing to rearrangement is long among the vehicles with an advance reservation.

8. The parking area management device according to claim 3, wherein
the rank setter sets a lower rank to a vehicle having a relatively large vehicle width.

9. The parking area management device according to claim 3, wherein
the rank setter sets a lower rank to a vehicle present in a space having a high space filling rate in a vehicle width direction with respect to a parkable region.

10. The parking area management device according to claim 3, wherein
the parking position determiner moves the vehicle without an advance reservation to a position different from the parking position when it is not possible to determine a parking position of a new vehicle even when rearrangement is performed.

11. The parking area management device according to claim 3, wherein
the recognizer acquires a recognition result of other vehicles in the parking area and recognizes outer dimensions of the other vehicles and a space filling rate in a vehicle width direction with respect to a parkable region.

12. The parking area management device according to claim 3, wherein
the parking position determiner determines whether the parking area will reach a full state in the future on the basis a reservation received by the reservation section and a parking position of the vehicle parked in advance in the parking area and determines that rearrangement is to be performed when it is determined that the full state will be reached.

13. A parking area management method for causing a computer to execute:
recognizing vehicles in a parking area; and
virtually setting parking frames in which the vehicles can park on the basis of outer dimensions of the recognized vehicles and map information of the parking area and determining the set parking frames as parking positions of vehicles in the parking area.

14. A non-transitory computer-readable recording medium having a program stored therein, the program causing a computer to execute:
recognizing vehicles in a parking area; and
virtually setting parking frames in which the vehicles can park on the basis of outer dimensions of the recognized vehicles and map information of the parking area and determining the set parking frames as parking positions of vehicles in the parking area.
